(19) United States
(12) Patent Application Publication
(10) Pub. No.: US 2025/0337254 A1
(43) Pub. Date: Oct. 30, 2025

(54) BATTERY PACK CHARGING METHOD AND POWER STORAGE SYSTEM

(71) Applicant: ENERGYWITH CO., LTD., Chiyoda-ku, Tokyo (JP)

(72) Inventors: Junya ITO, Chiyoda-ku, Tokyo (JP); Hiroshi ARITA, Chiyoda-ku, Tokyo (JP)

(73) Assignee: ENERGYWITH CO., LTD., Chiyoda-ku, Tokyo (JP)

(21) Appl. No.: 18/871,600

(22) PCT Filed: May 26, 2023
(86) PCT No.: PCT/JP2023/019808

§ 371 Date: Dec. 4, 2024

(30) Foreign Application Priority Data
Jun. 6, 2022 (JP) 2022-091549

(51) Int. Cl. H02J 7/00; H01M 10/44; H01M 10/46; H01M 50/512

(52) U.S. Cl. CPC H02J 7/0014; H01M 10/441; H01M 10/46; H01M 50/512; H02J 7/00714; H02J 7/007182

(57) ABSTRACT

A method of charging a battery pack is a method of charging a battery pack by charging, with one charger, a battery pack configured by connecting, in parallel, a plurality of storage batteries configured to store and release power, the method comprising: a detection step of detecting voltage and current values with respect to each of the storage batteries, which are connected in parallel; a determination step of determining whether or not a voltage detected for each of the storage batteries in the detecting step, is equal to or less than a first set voltage; and a charging step of charging the storage batteries, which are connected in parallel, wherein: in a first case, in which the voltages of all the storage batteries are determined to be equal to or less than the first set voltage in the determination step.

### TECHNICAL FIELD

The present disclosure relates to a method of charging a battery pack, and a power storage system.

### BACKGROUND ART

In power storage systems with storage batteries such as lead storage batteries, equalizing charge for allowing such storage batteries to be in the fully charged state is periodically carried out from the viewpoint of inhibiting such storage batteries from being degraded.

In recent years, power storage systems including multi-parallel storage battery modules in which a plurality of storage battery arrays (storage battery strings) provided with a single storage battery cell (single battery) or a plurality of storage battery cells connected in series are connected in parallel have been increasingly widespread according to requirements for higher capacities of storage batteries. Such a power storage system including a multi-parallel storage battery module is also preferably subjected to equalizing charge in the entire multi-parallel storage battery (see, for example, Patent Literature 1).

### CITATION LIST

### Patent Literature

Patent Literature 1: WO 2019/188889

### SUMMARY OF INVENTION

### Technical Problem

Patent Literature 1 discloses a power storage system characterized in that a switch is turned on to supply power from an AC/DC conversion device to a storage battery array, whereby not only equalizing charge for allowing the storage battery array to be in a fully charged state is performed, but also whether or not the equalizing charge is completed with respect to each storage battery array is determined, and the switch of the storage battery array that is determined to be completed with the equalizing charge is turned off. Such a power storage system has a need for turning off the switch and thus parallel-off of the storage battery array in which the equalizing charge is completed, for the purpose of prevention of over charge, and has the problem of having a difficulty in instantly responding to the requirement for discharge. For example, in a case in which the power storage system is used in a backup for emergency, a battery that is paralleled off by turning off the switch has a difficulty in instantly performing power supply. Therefore, power supply to a facility required to provide stable power supply, such as a data center, or a production line provided with precision equipment, has a risk of being hindered.

The power storage system of Patent Literature 1, although can supply power to the above facility, has a risk of having an insufficient capacity and being unable to ensure a required backup time, in a case in which a storage battery array with a switch turned on remains during equalizing charge. The power storage system also has a risk of being increased in the difference in voltage between storage battery arrays after discharge thereof and being unable to achieve parallel connection. The power storage system of Patent Literature 1 further needs to include a switch and a switch controller for performing equalizing charge, and a system configuration thereof is complicated.

From the foregoing, there is a demand for not only a procedure in which equalizing charge is performed by on-off control of a switch in a power storage system, but also a procedure in which the variation in state of charge between storage batteries with equalizing charge is suppressed and degradation of the storage batteries is suppressed.

An object of the disclosure is to provide a method of charging a battery pack, and a power storage system, in which the variation in state of charge between storage batteries and degradation of storage batteries with equalizing charge can be suppressed.

### Solution to Problem

The specific means for solving the above problems is as follows.

<1> A method of charging a battery pack by charging, with one charger, a battery pack configured by connecting, in parallel, a plurality of storage batteries configured to store and release power, the method comprising:
a detection step of detecting voltage and current values with respect to each of the storage batteries, which are connected in parallel;
a determination step of determining whether or not a voltage detected for each of the storage batteries in the detecting step, is equal to or less than a first set voltage; and
a charging step of charging the storage batteries, which are connected in parallel, wherein:
in a first case, in which the voltages of all the storage batteries are determined to be equal to or less than the first set voltage in the determination step, the charging comprises implementing constant-current charging and then implementing constant-voltage charging, or
in a second case, in which the voltage of at least one of the storage batteries is determined to exceed the first set voltage in the determination step, the charging comprises implementing constant-voltage charging, and
in either the first case or the second case, implementing the constant-voltage charging is terminated in a case in which the current values of all the storage batteries reach a set current value.

<2> The method of charging a battery pack according to <1>, wherein, in the first case, in which the voltages of all the storage batteries are equal to or less than the first set voltage, multi-stage constant-current charging, in which a charge current value is reduced in stages, is implemented.

<3> The method of charging a battery pack according to <2>, wherein, in a case in which the voltage of any one of the storage batteries is equal to or more than a second set voltage in constant-current charging, the charge current value is switched and a next stage of constant-current charging is implemented.

<4> The method of charging a battery pack according to <3>, wherein:
in a case in which the charge current value is switched and the next stage of constant-current charging is implemented, it is determined whether or not, after a lapse of a certain time from switching of the charge current value of the constant-current charging, the voltage of any one of the storage batteries has become equal to or more than the second set voltage as a result of the constant-current charging after the switching, and
in a case in which the voltage of any one of the storage batteries is determined to have become equal to or more than the second set voltage, the charge current value is further switched and a yet next stage of constant-current charging is implemented, or
in a case in which the voltages of all the storage batteries are determined to be less than the second set voltage, the constant-current charging is continued without further switching the charge current value.

<5> A power storage system, comprising:
a battery pack configured by connecting, in parallel, a plurality of storage batteries configured to store and release power;
one charger that is electrically connected to the battery pack and that charges the battery pack using power that is externally supplied;
a detection section that detects voltage and current values with respect to each of the storage batteries connected in parallel; and
a controller that controls charging of the storage batteries such that it is determined whether or not a voltage detected for each of the storage batteries, by the detection section, is equal to or less than a first set voltage and the following processing (1) or (2) is implemented based on a determination result:
(1) in a case in which the voltages of all the storage batteries, detected by the detection section, are determined to be equal to or less than a first set voltage, constant-current charging is implemented and then constant-voltage charging is implemented, and, in a case in which the current values of all the storage batteries reach a set current value, the constant-voltage charging is terminated; or
(2) in a case in which the voltage of at least one of the storage batteries among the storage batteries whose voltages are detected by the detection section is determined to exceed the first set voltage, constant-voltage charging is implemented and, in a case in which the current values of all the storage batteries reach a set current value, the constant-voltage charging is terminated.

<6> The power storage system according to <5>, further comprising a monitoring section that acquires the voltage and current values detected by the detection section, which is provided for each of the storage batteries connected in parallel, and monitors a state of the storage batteries,
wherein the monitoring section is provided with respect to each of the storage batteries.

<7> The power storage system according to <5> or <6>, further comprising a power supply section that supplies power via the charger to the storage batteries connected in parallel,
wherein the power supply section comprises a renewable energy power generation device that generates power with renewable natural energy.

<8> The power storage system according to any one of <5> to <7>, wherein the controller implements multi-stage constant-current charging in which a charge current value is reduced in stages, in the case of the processing (1).

<9> The power storage system according to <8>, wherein the controller switches a charge current value and implements a next stage of constant-current charging in a case in which the voltage of any one of the storage batteries reaches equal to or more than a second set voltage in the constant-current charging.

<10> The power storage system according to <9>, wherein:
the controller determines whether or not, after a lapse of a certain time from the switching of the charge current value of the constant-current charging, the voltage of any one of the storage batteries has reached equal to or more than the second set voltage as a result of the constant-current charging after the switching, and
in a case in which the voltage of any one of the storage batteries is determined to have reached equal to or more than the second set voltage, the controller controls the charging of the storage batteries such that the charge current value is further switched and a yet next stage of constant-current charging is implemented, or
in a case in which the voltages of all the storage batteries are determined to be less than the second set voltage, the controller controls the charging of the storage batteries such that the constant-current charging is continued without further switching of the charge current value.

### Advantageous Effect of Invention

The disclosure can provide a method of charging a battery pack, and a power storage system, in which the variation in state of charge between storage batteries and degradation of storage batteries with equalizing charge can be suppressed.

### BRIEF DESCRIPTION OF DRAWINGS

FIG. 1 is a diagram illustrating a configuration of one embodiment of the power storage system of the disclosure.

FIG. 2 is a flow diagram illustrating the flow of a charge control method during equalizing charge.

FIG. 3 is a timing chart illustrating one example of transition of voltage and current values during charge in a power storage system 100.

FIG. 4 is a timing chart illustrating another example of transition of voltage and current values during charge in the power storage system 100.

### DESCRIPTION OF EMBODIMENTS

Hereinafter, modes for carrying out the present invention are described in detail. However, the invention is not limited to the following embodiments. In the following embodiments, any component (also including element step or the like) is not essential, unless particularly clearly specified. The same also applies to any numerical value and range thereof, and such any numerical value and range thereof are not intended to limit the invention. Various variations and modifications can be made by those skilled in the art without departing from technical ideas of the disclosure.

The term “step” in the disclosure encompasses not only an independent step from other steps, but also a step that can achieve a predetermined object even in the case of being not clearly distinguished from other steps.

A numerical value range represented by “(from) . . . to . . . ” in the disclosure includes numerical values described before and after “to” as a lower limit and an upper limit, respectively.

An upper limit value or a lower limit value described by a certain numerical value range in the form of a numerical value range described stepwise in the disclosure may be replaced with an upper limit value or a lower limit value of other numerical value range described stepwise. An upper limit value or a lower limit value described by a certain numerical value range in the form of a numerical value range described in the disclosure may be replaced with a value indicated in Examples.

### Method of Charging Battery Pack

The method of charging a battery pack of the disclosure is a method of charging a battery pack by charging, with one charger, a battery pack configured by connecting, in parallel, a plurality of storage batteries configured to store and release power, the method including:
a detection step of detecting a voltage with respect to each of the storage batteries, which are connected in parallel, a determination step of determining whether or not a voltage detected for each of the storage batteries, in the detection step, is equal to or less than a first set voltage, and a charge step of charging the storage batteries connected in parallel,
in a first case in which the voltages of all the storage batteries are determined to be equal to or less than the first set voltage in the determination step, the charge step is a constant-current and constant-voltage charging step of implementing constant-current charging and then implementing constant-voltage charging, or
in a second case in which the voltage of at least one of the storage batteries is determined to exceed the first set voltage in the determination step, the charge step is a constant-voltage charging step of implementing constant-voltage charging, and
the constant-voltage charging in the constant-current and constant-voltage charging step and the constant-voltage charging step is terminated in a case in which current values of all the storage batteries reach a set current value.

The variation in state of charge between the storage batteries and degradation of the storage batteries with equalizing charge can be suppressed in the method of charging a battery pack of the disclosure. The reason why this effect is exerted is presumed as follows. The following presumption herein is not intended to interpret the voltage variation suppression element of the disclosure in a limited manner, and describes one example.

In the method of charging a battery pack of the disclosure, in a case in which the voltages of all the storage batteries among the storage batteries connected in parallel are determined to be equal to or less than the first set voltage, constant-current charging is implemented and then constant-voltage charging is implemented. This enables shortening of the charge time and also enables suppression of heat generation in the storage batteries due to shortening of the charge time. As a result, degradation of the storage batteries can be suppressed. Furthermore, constant-voltage charging is terminated in a case in which the current values of all the storage batteries reach a set current value, whereby a storage battery that does not reach an objective state of charge (for example, SOC 100%) is inhibited from occurring and the variation in state of charge between storage batteries with equalizing charge can be suppressed. In a case in which the voltage of at least one storage battery among the storage batteries connected in parallel exceeds the first set voltage after constant-current charging is implemented, transfer to constant-voltage charging may be performed. For example, in a case in which constant-current charging is multi-stage constant-current charging, whether or not the voltage of at least one storage battery exceeds the first set voltage after constant-current charging is implemented is determined at the state of each constant-current charging, and transfer to constant-voltage charging may be performed in a case in which the voltage is determined to exceed the first set voltage.

In the method of charging a battery pack of the disclosure, in a case in which the voltage of at least one storage battery among the storage batteries connected in parallel is determined to exceed the first set voltage, constant-current charging is not implemented, but constant-voltage charging is implemented. Delay in charge control causes transfer to the next step to take a certain degree of time, and the voltage of the storage battery can be increased during this time. Therefore, the start of constant-current charging at a high voltage to a certain extent causes a risk of an excess increase in the voltage of the storage battery. Accordingly, it is necessary, from the viewpoint of prevention of an excess increase in voltage, to implement constant-voltage charging without constant-current charging implemented, in a case in which the voltage of at least one storage battery exceeds the first set voltage. Thus, an excess increase in the voltage of a storage battery whose voltage exceeds the first set voltage is suppressed, and degradation of the storage batteries can be suppressed. The above determination is performed, whereby an excess increase in voltage can be prevented even at a high set current value of constant-current charging in the case of constant-current charging being needed, and thus the charge time can be shortened. Furthermore, constant-voltage charging is terminated in a case in which the current values of all the storage batteries reach a set current value, whereby a storage battery that does not reach an objective state of charge (for example, SOC 100%) is inhibited from occurring and the variation in state of charge between storage batteries with equalizing charge can be suppressed.

In the method of charging a battery pack of the disclosure, the charge current value is decreased according to progression of charge in constant-voltage charging, and does not exceed the set voltage of constant-voltage charging. Furthermore, the charge current more flows to a storage battery to which the charge current easily flows, among the storage batteries connected in parallel, and thus the charge current hardly flows to a storage battery previously fully charged and tends to disproportionately flow to a storage battery not fully charged. Thus, over charge does not occur in any storage battery even in a case in which parallel-off of a storage battery in which equalizing charge is completed is not performed by turning off a switch.

It is not necessary in the method of charging a battery pack of the disclosure to perform parallel-off by turning off a switch because constant-voltage charging is adopted and over charge of a storage battery does not occur. This makes it easy to instantly respond to the requirement for discharge. Furthermore, a switch and a switch controller for performing equalizing charge are not necessarily needed, and therefore equalizing charge suppressed in the variation in the state of charge among the storage batteries can be performed by a power storage system having a simplified system configuration.

Hereinafter, the method of charging a battery pack of the disclosure is described with reference to one embodiment of the power storage system of the disclosure. The method of charging a battery pack of the disclosure is not limited to any method with the power storage system of the disclosure.

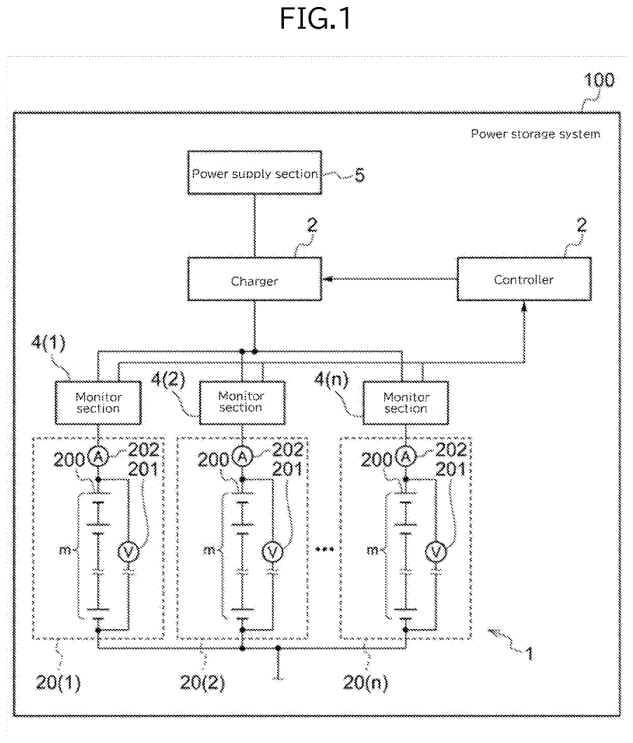

FIG. 1 is a diagram illustrating a configuration of one embodiment of the power storage system of the disclosure. As illustrated in FIG. 1, a power storage system 100 according to one embodiment includes a battery pack 1 in which n storage batteries 20(1) to 20(n) are connected in parallel, a charger 2, a controller 3, monitor sections 4(1) to 4(n), and a power supply section 5. Each of the storage batteries 20(1) to 20(n) is a storage battery string in which a plurality of (m in FIG. 1) storage batteries 200 is connected in series. In the disclosure, each of the storage batteries may be one storage battery or may be the above storage battery string. n and m in FIG. 1 are not particularly limited as long as n is an integer of 1 or more and m is an integer of 2 or more.

The power storage system 100 includes a voltmeter 201 that measures the voltage of each of the storage batteries 20(1) to 20(n) and an ammeter 202 that measures the charge current value and the discharge current value of each of the storage batteries 20(1) to 20(n), in a detection section that detects voltage and current values. The voltmeter 201 and the ammeter 202 are provided with respect to each of the storage batteries 20(1) to 20(n). The voltage and current values are measured with respect to each of the storage batteries 20(1) to 20(n).

Examples of each of the storage batteries 200 include a lead storage battery.

The power storage system 100 includes one charger 2. Thus, for example, a system configuration can be simplified and a reduction in cost can be achieved as compared with a case in which a plurality of chargers is prepared with respect to each storage battery.

The charger 2 is controlled by the controller 3, and may have a function to mutually convert power among the power supply section 5, the battery pack 1, and a load not illustrated, and control transmission and reception of power among the power supply section 5, the battery pack 1, and the load. For example, the charger 2 may convert alternating-current power (AC) from the power supply section 5 into direct-current power (DC) and supply the power to the battery pack 1, and the charger 2 may include, for example, a DC/DC converter, an AC/DC converter (AC/DC), or a switch circuit.

The power storage system 100 includes the controller 3. The controller 3 is a device that performs control about charge and discharge of the power storage system 100.

The power storage system 100 includes the monitor sections 4(1) to 4(n). The monitor sections 4(1) to 4(n) sequentially acquire the voltage and current values measured by the voltmeter 201 and the ammeter 202, and monitor the states of the storage batteries 20(1) to 20(n). For example, the monitor sections 4(1) to 4(n) are each a BMU (Battery Management Unit). More specifically, the monitor sections 4(1) to 4(n) are provided respectively for the storage batteries 20(1) to 20(n), and sequentially acquire the voltage and current values measured by the voltmeter 201 and the ammeter 202 provided with respect to each of the storage batteries 20(1) to 20(n). Thus, the charge/discharge state with respect to each of the storage batteries 20(1) to 20(n) can be monitored, and equalizing charge can be continued until all the storage batteries 20(1) to 20(n) reach a fully charged state. The voltage and current values sequentially acquired in the monitor sections 4(1) to 4(n) respectively for the storage batteries 20(1) to 20(n) are combined, whereby the controller 3 determines whether or not equalizing charge of all the storage batteries 20(1) to 20(n) is completed. The variation in the state of charge with respect to each of the storage batteries is suppressed in determination of completion of equalizing charge.

The controller 3 implements constant-current charging (CC charge), constant-voltage charging (CV charge), or the like based on data, such as voltage and current values, obtained by the monitor sections 4(1) to 4(n). For example, the controller 3 is an EMS (Energy Management System).

The power storage system 100 includes the power supply section 5. The power supply section 5 supplies power via the charger 2 to the storage batteries 20(1) to 20(n) connected in parallel. The power supply section 5 may be a device that supplies energy such as thermal power energy or nuclear energy to the storage batteries 20(1) to 20(n), or may be a device that supplies renewable natural energy to the storage batteries 20(1) to 20(n). The power supply section 5 may include a renewable energy power generation device that generates power by use of renewable natural energy.

Examples of such renewable energy include solar light, wind power, biomass, water power, geothermal heat, solar heat, tidal current, or tidal power.

The controller 3 and the monitor sections 4(1) to 4(n) are realized by a data processing device having a CPU (Central Processing Unit), a ROM (Read Only Memory), a RAM (Random Access Memory), a storage, a communication interface (I/F), and the like.

The CPU is a central processing unit, and executes various programs and/or controls each section. The CPU reads a program from the ROM or storage, and executes the program with the RAM as a workspace. The CPU performs control of each constitution (for example, control of charge/discharge, determination of the voltage and current values, and the like, determination of end of charge, and the like) and various kinds of computation processing, according to the program memorized in the ROM or storage. For example, the CPU in the controller 3 preferably performs charge control of each of the storage batteries 20(1) to 20(n), for example, implementing of processing (1) or (2) described below, determination of the voltage and current values, and the like, and determination of end of charge. The CPU in the monitor sections 4(1) to 4(n) preferably sequentially acquires the voltage and current values measured by the voltmeter 201 and the ammeter 202, and monitors the states of the storage batteries 20(1) to 20(n) (the presence of over charge or over discharge, the state of charge, and the like).

The ROM stores various programs and various kinds of data. The RAM serves as a workspace and temporarily memorizes the programs or data. The storage is configured from a memory device such as an HDD (Hard Disk Drive) or an SSD (Solid State Drive), and stores various programs, including an operating system, and various kinds of data.

The communication interface is an interface for communication with other instrument. For example, a wired communication standard such as Ethernet (registered trademark) or FDDI, or a wireless communication standard such as 4G, 5G, or Wi-Fi (registered trademark) is used in the above communication.

Hereinafter, a charge method with the power storage system 100 is described.

The charge method with the power storage system 100 includes a detection step of detecting the voltage of each of the storage batteries 20(1) to 20(n), a determination step of determining whether or not the voltage of each of the storage batteries 20(1) to 20(n), detected in the detection step, is equal to or less than the first set voltage, and a charge step of charging each of the storage batteries 20(1) to 20(n) connected in parallel.

The detection step is performed by measuring the voltage of each of the storage batteries 20(1) to 20(n) with the voltmeter 201. The information on the voltage measured is acquired by each of the monitor sections 4(1) to 4(n).

The determination step is performed by determining whether or not the voltage of each of the storage batteries 20(1) to 20(n) is equal to or less than the first set voltage, based on the information on the voltage measured, acquired by each of the monitor sections 4(1) to 4(n), by the controller 3. The controller 3 controls charge of each of the storage batteries 20(1) to 20(n) so that the following processing (1) or (2) is implemented based on the determination result.
(1) in a case in which the voltages of all the storage batteries 20(1) to 20(n), measured with the voltmeter 201, are determined to be equal to or less than the first set voltage, constant-current charging is implemented and then constant-voltage charging is implemented, and, in a case in which the current values of all the storage batteries 20(1) to 20(n) reach a set current value, constant-voltage charging is terminated.
(2) in a case in which the voltage of at least one storage battery, among the storage batteries 20(1) to 20(n) subjected to voltage measurement with the voltmeter 201, is determined to exceed the first set voltage, constant-voltage charging is implemented, and, in a case in which the current values of all the storage batteries 20(1) to 20(n) reach a set current value, constant-voltage charging is terminated.

In a case in which the voltages of all the storage batteries 20(1) to 20(n), measured with the voltmeter 201, are determined to be equal to or less than the first set voltage, as in the above processing (1), the controller 3 preferably implements multi-stage constant-current charging in which a charge current value is reduced in stages, as constant-current charging. Thus, shortening of the charge time and suppression of heat generation in the storage batteries is more suitably made possible.

In a case in which the voltage of at least one storage battery, among the storage batteries 20(1) to 20(n), reaches equal to or more than a second set voltage in constant-current charging, it is preferable to switch a charge current value and implement the next stage of constant-current charging (for example, constant-current charging at a lower charge current value). Thus, shortening of the charge time and suppression of degradation of the storage batteries is more suitably made possible.

The controller 3 may determine whether or not, after a certain time from switching of the charge current value of the constant-current charging has lapsed, the voltage of any one of the storage batteries reaches equal to or more than the second set voltage as a result of the constant-current charging made by the switching in a case in which the multi-stage constant-current charging is implemented. In a case in which the voltage of any one of the storage batteries, among the storage batteries 20(1) to 20(n), is determined to reach equal to or more than the second set voltage, a charge current value may be further switched and a yet next stage of constant-current charging may be implemented. In this regard, in a case in which the voltage of any one of the storage batteries is not determined to reach equal to or more than the second set voltage, namely, in a case in which the voltages of all the storage batteries 20(1) to 20(n) are determined to be less than the second set voltage, constant-current charging may be continued without further switching of the charge current value.

In a case in which the charge current value of constant-current charging is switched, the voltages of the storage batteries tend to be reduced according to a lapse of time. Therefore, an erroneous determination about switching to the next step can be suppressed by determining whether or not the voltages are equal to or more than the second set voltage, after a certain time (also referred to as “determination dead time”.) from switching of the charge current value of constant-current charging has lapsed.

The determination dead time may be a time equal to or more than the time until the voltage of a storage battery to be subjected to a switch determination is decreased to a voltage less than the second set voltage, with, as the point of origin, a switch instruction of the charge current value of constant-current charging by each of the monitor sections 4(1) to 4(n), for example, BMU, or may be a time equal to or more than the time until a decrease in the voltage of a storage battery to be subjected to a switch determination is stabilized, with, as the point of origin, the above switch instruction of the charge current value of constant-current charging.

According to a lapse of time from switching of the charge current value of constant-current charging, a decrease in the voltage of the storage battery is stabilized and the voltage of the storage battery is gradually increased as a result of the constant-current charging made by switching. The upper limit of the determination dead time is preferably a time in which the voltage of the storage battery is not too high as a result of the constant-current charging made by switching, and the upper limit of the determination dead time is preferably set in consideration of the fear that the voltage of the storage battery exceeds an operating upper limit voltage until transfer to the next step due to delay of charge control. For example, a time is preferred in which the voltage of any one of the storage batteries is not equal to or more than the operating upper limit voltage of charge, or in which the voltage of any one of the storage batteries does not reach a value equal to or more than the second set voltage from a value less than the second set voltage.

The lower limit of the determination dead time, for example, may be 5 seconds or more, may be 6 seconds or more, or may be 10 seconds or more. The upper limit of the determination dead time, for example, may be 40 seconds or less, may be 30 seconds or less, or may be 20 seconds or less.

The lower limit of the determination dead time may be a time actually measured until a decrease in the voltage of the storage battery, or a time obtained by adding a margin to the time actually measured.

In the above processing (1), constant-current charging is implemented and then constant-voltage charging is implemented. For example, in a case in which the voltage of any one of the storage batteries is equal to or more than a certain value, switching from constant-current charging to constant-voltage charging can be made. In a case in which multi-stage constant-current charging is implemented, constant-current charging of a predetermined number of stages (for example, three stages) is implement, and, in a case in which the voltage is equal to or more than the second set voltage, switching from constant-current charging to constant-voltage charging may be made. Alternatively, in a case in which multi-stage constant-current charging is implemented, switching from constant-current charging to constant-voltage charging may be made in a case in which the charge current value of constant-current charging, of any one of the storage batteries, decreased stepwise is decreased to a certain value as a target of constant-voltage charging and the voltage thereof reaches equal to or more than the second set voltage.

Constant-voltage charging is performed, whereby the current values of the storage batteries 20(1) to 20(n) are gradually decreased. Constant-voltage charging in the processing (1) is terminated in a case in which the current values of all the storage batteries 20(1) to 20(n) each reach a set current value. The foregoing enables the variation in voltage in all the storage batteries 20(1) to 20(n) to be suppressed.

In this regard, in a case in which it is determined as in the above processing (2) that the voltage of at least one storage battery among the storage batteries 20(1) to 20(n) subjected to voltage measurement with the voltmeter 201 exceeds the first set voltage, constant-voltage charging is implemented. In other words, in a case in which a storage battery whose voltage is determined to exceed the first set voltage as a target voltage is present, constant-voltage charging is performed without performing constant-current charging. Constant-voltage charging is terminated in a case in which the current values of all the storage batteries 20(1) to 20(n) each reach a set current value. Thus, suppression of degradation of the storage batteries and shortening of the charge time is more suitably made possible.

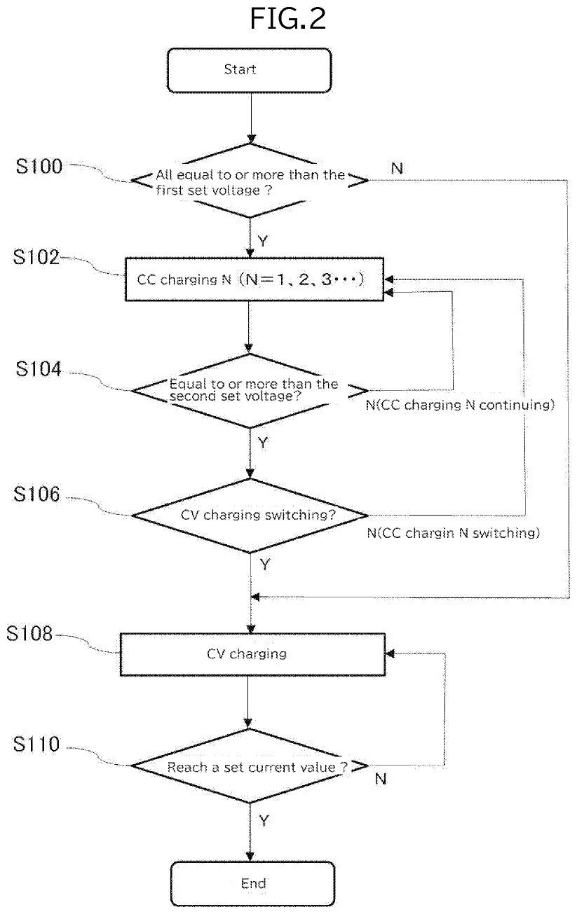

One example of a charge control method in the power storage system 100 is described in detail with reference to FIG. 2. FIG. 2 is a flow diagram illustrating the flow of a charge control method during equalizing charge.

Whether or not the voltages of all the storage batteries 20(1) to 20(n), measured with the voltmeter 201, are equal to or less than the first set voltage is determined in Step S100.

In a case in which the voltages of all the storage batteries 20(1) to 20(n) are equal to or less than the first set voltage in Step S100 (in the case of Y in FIG. 1), constant-current charging 1 (CC charge 1) is implemented in Step S102.

In this regard, in a case in which the voltages of all the storage batteries 20(1) to 20(n) are not equal to or less than the first set voltage in Step S100 (in the case of N in FIG. 1), namely, in a case in which the voltage of at least one storage battery among the storage batteries 20(1) to 20(n) exceeds the first set voltage, constant-current charging is not implemented, but constant-voltage charging (CV charge) is implemented in Step S108.

In a case in which constant-current charging 1 (CC charge 1) is implemented in Step S102, whether or not the voltage of any one of the storage batteries, measured in the voltmeter 201, reaches equal to or more than the second set voltage is determined in Step S104. In a case in which the voltage does not reach equal to or more than the second set voltage, constant-current charging 1 is continued. In a case in which the voltage reaches equal to or more than the second set voltage, transfer to Step S106 is performed.

Whether or not switching to constant-voltage charging (CV charge) is performed is determined in Step S106. In a case in which it is determined that switching to constant-voltage charging is not performed, the charge current value of constant-current charging 1 is switched, and transfer to constant-current charging 2 (CC charge 2) lower in charge current value than constant-current charging 1 is performed. Constant-current charging 2 is implemented in Step S102. Step S102 to Step S106 are repeated, whereby multi-stage constant-current charging in which a charge current value is reduced in stages (CC charge N, N=1, 2, 3 . . . in the Figure) is implemented.

In a case in which predetermined multi-stage CC charge (for example, three-stage CC charge 1 to CC charge 3) is implemented and the voltage of any one of the storage batteries, measured with the voltmeter 201 in implementing of CC charge 3, reaches equal to or more than the second set voltage, switching to constant-voltage charging is determined in Step S106.

In a case in which multi-stage constant-current charging is implemented and switching to constant-voltage charging is determined in Step S106, constant-current charging N is switched to constant-voltage charging, and constant-voltage charging is implemented in Step S108. Also, in a case in which the voltages of all the storage batteries 20(1) to 20(n) are not equal to or less than the first set voltage in Step S100, constant-voltage charging is implemented in Step S108.

Whether or not the current values of all the storage batteries 20(1) to 20(n) reach a set current value is determined in Step S110. In a case in which the values do not reach a set current value, constant-voltage charging is continued. In a case in which the values reach a set current value, constant-voltage charging is terminated.

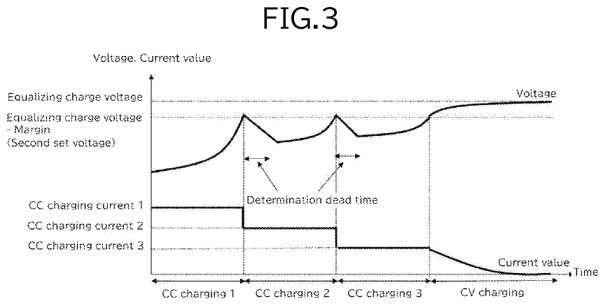

The transition of voltage and current values during charge in the power storage system 100 in the above processing (1) is described with reference to FIG. 3. FIG. 3 is a timing chart illustrating one example of the transition of voltage and current values during charge in the power storage system 100.

FIG. 3 illustrates transition of the current value and voltage in a case in which multi-stage constant-current charging in which a charge current value is reduced in stages is performed at three stages as constant-current charging and then constant-voltage charging is performed. The second set voltage in FIG. 3 is defined as a value obtained by subtracting a margin from the equalizing charge voltage. The multi-stage constant-current charging may be two-stage constant-current charging, or four-or more-stage constant-current charging.

In a case in which constant-current charging 1 is implemented and the voltage of any one of the storage batteries reaches equal to or more than the second set voltage, the charge current value is switched and the next stage of constant-current charging 2 is implemented. After the determination dead time from switching of the charge current value has lapsed, whether or not the voltage of any one of the storage batteries reaches equal to or more than the second set voltage by constant-current charging 2 made by the switching is determined.

In a case in which constant-current charging 2 is implemented and the voltages of the storage batteries are gradually increased, and the voltage of any one of the storage batteries reaches equal to or more than the second set voltage, the charge current value is switched and the next stage of constant-current charging 3 is implemented. After the determination dead time from switching of the charge current value has lapsed, whether or not the voltage of any one of the storage batteries reaches equal to or more than the second set voltage by constant-current charging 3 made by the switching is determined.

In a case in which the voltage of any one of the storage batteries reaches equal to or more than the second set voltage by constant-current charging 3, constant-current charging 3 is switched to constant-voltage charging and the constant-voltage charging is implemented. In a case in which constant-voltage charging is implemented and the current values of all the storage batteries 20(1) to 20(n) reach a set current value, the constant-voltage charging is terminated.

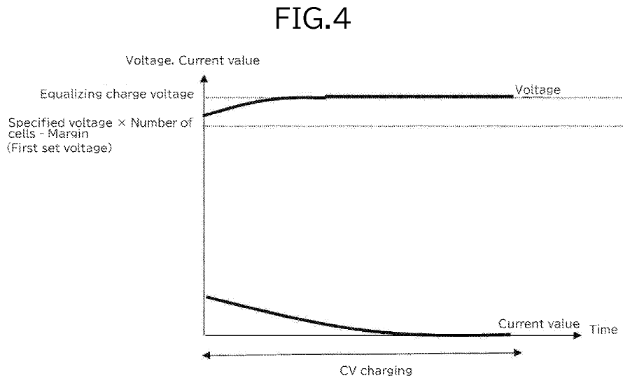

The transition of voltage and current values during charge in the power storage system 100 in the above processing (2) is described with reference to FIG. 4. FIG. 4 is a timing chart illustrating another example of the transition of voltage and current values during charge in the power storage system 100.

The first set voltage in FIG. 4 is defined as a value obtained by subtracting a margin from the product of Specified voltage (V/cell)×Number of cells. The number of cells corresponds to m in FIG. 1.

The specified voltage may be, for example, the voltage at the start of charge in which the voltage of at least one storage battery can reach the operating upper limit voltage in constant-current charging under the assumption that constant-current charging is performed. In other words, in a case in which the voltage of at least one storage battery can exceed the operating upper limit voltage in constant-current charging performed (a case in which the voltage at the start of charge exceeds the specified voltage), it is preferable that constant-voltage charging is performed without performing constant-current charging, as in the above processing (2). In a case in which the voltages of all the storage batteries cannot exceed the operating upper limit voltage in constant-current charging performed (a case in which the voltage at the start of charge is equal to or less than the specified voltage), it is preferable that constant-current charging and constant-voltage charging are performed as in the above processing (1).

The voltage at the start of charge, which can reach the operating upper limit voltage in constant-current charging, can be calculated from the rate of increase in voltage in constant-current charging, the time of constant-current charging implemented, the operating upper limit voltage, and the like.

The specified voltage may be, for example, the voltage at the start of charge in which the voltage of at least one storage battery can reach the operating upper limit voltage after switching of the charge current value and before a lapse of the determination dead time under the assumption that multi-stage constant-current charging is performed. In other words, in a case in which the voltage of at least one storage battery can exceed the operating upper limit voltage in multi-stage constant-current charging performed, it is preferable that constant-voltage charging is performed without performing constant-current charging, as in the above (2). In a case in which the voltages of all the storage batteries cannot exceed the operating upper limit voltage in multi-stage constant-current charging performed, it is preferable that multi-stage constant-current charging and constant-voltage charging are performed as in the above processing (1).

FIG. 4 indicates that constant-voltage charging is implemented by a determination in which the voltage of at least one storage battery among the storage batteries 20(1) to 20(n) subjected to voltage measurement with the voltmeter 201 exceeds the first set voltage. Constant-voltage charging is terminated in a case in which the current values of all the storage batteries 20(1) to 20(n) reach a set current value.

The disclosure of Japanese Patent Application No. 2022-091549 filed on Jun. 6, 2022 is herein incorporated by reference in its entirety.

All documents, patent applications, and technical standards described herein are herein incorporated by reference, as if each individual document, patent application, and technical standard were specifically and individually indicated to be incorporated by reference.

### REFERENCE SIGNS LIST

1 Battery pack
2 Charger
3 Controller
4(1) to 4(n) Monitor section
5 Power supply section
20(1) to 20(n) Storage battery
100 Power storage system

1. A method of charging a battery pack by charging, with one charger, a battery pack configured by connecting, in parallel, a plurality of storage batteries configured to store and release power, the method comprising:
a detection step of detecting voltage and current values with respect to each of the storage batteries, which are connected in parallel;
a determination step of determining whether or not a voltage detected for each of the storage batteries in the detecting step, is equal to or less than a first set voltage; and
a charging step of charging the storage batteries, which are connected in parallel, wherein:
in a first case, in which the voltages of all the storage batteries are determined to be equal to or less than the first set voltage in the determination step, the charging comprises implementing constant-current charging and then implementing constant-voltage charging, or
in a second case, in which the voltage of at least one of the storage batteries is determined to exceed the first set voltage in the determination step, the charging comprises implementing constant-voltage charging, and
in either the first case or the second case, implementing the constant-voltage charging is terminated in a case in which the current values of all the storage batteries reach a set current value.

2. The method of charging a battery pack according to claim 1, wherein, in the first case, in which the voltages of all the storage batteries are equal to or less than the first set voltage, multi-stage constant-current charging, in which a charge current value is reduced in stages, is implemented.

3. The method of charging a battery pack according to claim 2, wherein, in a case in which the voltage of any one of the storage batteries is equal to or more than a second set voltage in constant-current charging, the charge current value is switched and a next stage of constant-current charging is implemented.

4. The method of charging a battery pack according to claim 3, wherein:
in a case in which the charge current value is switched and the next stage of constant-current charging is implemented, it is determined whether or not, after a lapse of a certain time from switching of the charge current value of the constant-current charging, the voltage of any one of the storage batteries has become equal to or more than the second set voltage as a result of the constant-current charging after the switching, and
in a case in which the voltage of any one of the storage batteries is determined to have become equal to or more than the second set voltage, the charge current value is further switched and a yet next stage of constant-current charging is implemented, or
in a case in which the voltages of all the storage batteries are determined to be less than the second set voltage, the constant-current charging is continued without further switching the charge current value.

5. A power storage system, comprising:
a battery pack configured by connecting, in parallel, a plurality of storage batteries configured to store and release power;
one charger that is electrically connected to the battery pack and that charges the battery pack using power that is externally supplied;
a detection section that detects voltage and current values with respect to each of the storage batteries connected in parallel; and
a controller that controls charging of the storage batteries such that it is determined whether or not a voltage detected for each of the storage batteries, by the detection section, is equal to or less than a first set voltage and the following processing (1) or (2) is implemented based on a determination result:
(1) in a case in which the voltages of all the storage batteries, detected by the detection section, are determined to be equal to or less than a first set voltage, constant-current charging is implemented and then constant-voltage charging is implemented, and, in a case in which the current values of all the storage batteries reach a set current value, the constant-voltage charging is terminated; or
(2) in a case in which the voltage of at least one of the storage batteries among the storage batteries whose voltages are detected by the detection section is determined to exceed the first set voltage, constant-voltage charging is implemented and, in a case in which the current values of all the storage batteries reach a set current value, the constant-voltage charging is terminated.

6. The power storage system according to claim 5, further comprising a monitoring section that acquires the voltage and current values detected by the detection section, which is provided for each of the storage batteries connected in parallel, and monitors a state of the storage batteries,
wherein the monitoring section is provided with respect to each of the storage batteries.

7. The power storage system according to claim 6, further comprising a power supply section that supplies power via the charger to the storage batteries connected in parallel,
wherein the power supply section comprises a renewable energy power generation device that generates power with renewable natural energy.

8. The power storage system according to claim 6, wherein the controller implements multi-stage constant-current charging in which a charge current value is reduced in stages, in the case of the processing (1).

9. The power storage system according to claim 8, wherein the controller switches a charge current value and implements a next stage of constant-current charging in a case in which the voltage of any one of the storage batteries reaches equal to or more than a second set voltage in the constant-current charging.

10. The power storage system according to claim 9, wherein:
the controller determines whether or not, after a lapse of a certain time from the switching of the charge current value of the constant-current charging, the voltage of any one of the storage batteries has reached equal to or more than the second set voltage as a result of the constant-current charging after the switching, and
in a case in which the voltage of any one of the storage batteries is determined to have reached equal to or more than the second set voltage, the controller controls the charging of the storage batteries such that the charge current value is further switched and a yet next stage of constant-current charging is implemented, or
in a case in which the voltages of all the storage batteries are determined to be less than the second set voltage, the controller controls the charging of the storage batteries such that the constant-current charging is continued without further switching of the charge current value.

11. The power storage system according to claim 7, wherein the controller implements multi-stage constant-current charging in which a charge current value is reduced in stages, in the case of the processing (1).

12. The power storage system according to claim 11, wherein the controller switches a charge current value and implements a next stage of constant-current charging in a case in which the voltage of any one of the storage batteries reaches equal to or more than a second set voltage in the constant-current charging.

13. The power storage system according to claim 12, wherein:
the controller determines whether or not, after a lapse of a certain time from the switching of the charge current value of the constant-current charging, the voltage of any one of the storage batteries has reached equal to or more than the second set voltage as a result of the constant-current charging after the switching, and
in a case in which the voltage of any one of the storage batteries is determined to have reached equal to or more than the second set voltage, the controller controls the charging of the storage batteries such that the charge current value is further switched and a yet next stage of constant-current charging is implemented, or
in a case in which the voltages of all the storage batteries are determined to be less than the second set voltage, the controller controls the charging of the storage batteries such that the constant-current charging is continued without further switching of the charge current value.
